(19) United States
(12) Patent Application Publication
(10) Pub. No.: US 2006/0247867 A1
(43) Pub. Date: Nov. 2, 2006

(54) Customized and dynamic association of probe type with feature extraction algorithms

(76) Inventors: Glenda C. Delenstarr, Redwood City, CA (US); Peter G. Webb, Menlo Park, CA (US); Charles D. Troup, Livermore, CA (US); Jayati Ghosh, San Jose, CA (US); Christian A. Le Cocq., Menlo Park, CA (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/414,005

(22) Filed: Apr. 28, 2006

Related U.S. Application Data
(60) Provisional application No. 60/676,391, filed on Apr. 29, 2005.

(51) Int. Cl. G06F 19/00

(52) U.S. Cl. 702/19; 702/22

(57) ABSTRACT

Systems, methods and computer readable media for extracting data from features on a chemical array, using a feature extraction module including feature extraction algorithms configured to calculate characteristics of array features. A reference table is provided that associates probe names of probes contained on the array with at least one additional identifier. The reference table is accessible by the feature extraction module to convert any one of the at least one additional identifiers to the probe names, and the probe names to at least one of the at least one additional identifiers.

### CROSS-REFERENCE

This application claims the benefit of U.S. Provisional Application No. 60/676,391, filed Apr. 29, 2006, to which we claim priority and which application is incorporated herein by reference.

### BACKGROUND OF THE INVENTION

Users of microarrays need systems to extract signal and/or log ratio data from the features on the arrays. Such systems software packages generally perform multiple algorithms, including, but not limited to spot/feature finding algorithms, flagging of outliers, various background subtraction algorithms, dye normalization algorithms, and error modeling. Each of these algorithms may be optimized to work with specific types of probes and features. For example, some algorithms may screen for use of specific probe sequences or probe types. Some algorithms require that the features considered be only from an inlier filtered set of features; that is those that pass flagging algorithms identifying outliers.

Current feature extraction systems may employ one or more of several methods of assigning specific probes to be used by specific algorithms, each having drawbacks and limitations. Alternatively, a system may simply base its processing upon all probes on the array for all algorithms. Generally, this occurs if a system/software package has no prior knowledge of the types of probes on an array, or if the array has no probe types specified. This approach significantly limits the ability of the algorithms to specifically target probe types required for accuracy of results from algorithms that require this degree of specificity. For example, in order to tune a background subtraction algorithm to be most accurate, the algorithm employed generally must consider only negative control probes for an estimation of the background level, in order to perform background subtraction most accurately.

One method of assigning specific probes uses “hard-coded” lists of specific probes, by probe name, listing those probe names that are specifically assigned to specific algorithms. With this approach, if an array has probe names specified and the feature extraction system/software has access to the specification of probe names, and the probe names match with those in the hard-coded lists, then the algorithms of the system can select specific probe names in accordance with those specified in the associated hard-coded list. For example, a background estimation algorithm may select all probes named “Negative_XXX” (where “XXX” is an open variable) for estimation of background. There are at least two significant problems with this approach. One is that an array being processed may not have the specific names indicated by the hard-coding associated with an algorithm to be run. A second is that probe names require parsing in order to select them in accordance with a specific hard coding, and this process can be very non-robust. For example, it is not unusual for array manufacturers to change probe naming conventions. In such an occurrence, the existing hard-codings may not be able to identify probes named according to a new probe naming convention, which should otherwise be included for consideration by a specific algorithm. Further, array manufacturers may add new probes with new probe names that may be useful for specific algorithm use, but once the feature extraction system/software package is commercialized, it is difficult to update the hard coding with the new probe names, and this typically requires the release of a new version of at least the feature extraction software package.

Another approach employs hard-coding to identify specific probes by probe type for use with a specific algorithm. Thus, if an array has a probe type specified and the software has access to this specification, then algorithms can select specific probe types, based on the hard-coded specification contained with the software package to run with specific algorithms. For example, an algorithm for estimating background level may specify the use of all probes with probe type identified as “NegativeControl”. This approach also has significant drawbacks. For example, an array being processed may not have probe type specifications. Also, the hard coding of the feature extraction system/software may not recognize one or more probe types specified on an array, since probe types tend to be manufacturer-specific. Still further, manufacturers may add new probe types that may be useful for particular algorithm use, but once the feature extraction software package is commercialized, it is difficult to update the hard coded information to incorporate specification of the new probe types, and therefore this typically requires the release of a new version of feature extraction software.

Users of feature extraction systems may wish to experiment with different probe type associations for various algorithms, but currently have no ability to do so, as they cannot change the hard-coded algorithms.

Feature extraction systems may have several methods for applying filter sets to algorithms in order to be further selective about features to be used for processing by an algorithm. For example, an algorithm may use features that pass manual outlier flagging, for example when a user manually inspects an array and flags features that appear non-uniform or otherwise unfit for processing. Another approach is to use only features that pass flagging algorithms run by the feature extraction system. For example, algorithms may be specified to use only features that have not been flagged by a population analysis filtering algorithm that flags population outliers for replicated features; algorithms may be specified to use only features that have not been flagged by a non-uniformity analysis at the pixel level of the feature image; algorithms may be specified to use only features that have not been flagged as having a saturated signal level that exceeds the dynamic range of the feature extraction system; etc. Further, combinations of these filters may be applied to determine features for final selection and use by a particular algorithm.

Current methods hard code the required filter set to be applied to each specific algorithm. For example, an algorithm may be hard coded for application of a population analysis filtering algorithm that flags population outliers for replicated features, thereby excluding outliers and non-uniform features from the processing, even though those features would ordinarily be considered as meeting the specified probe name or probe type requirement. Current methods for applying filter sets also have significant drawbacks. Since the feature extraction software hard-codes the required filter-set for each algorithm, as algorithm needs change, developers need to find all references to filter sets and change them individually. Users of a feature extraction system may wish to experiment with applying different filter-sets to algorithms, but cannot change the hard-coded software.

There is a need for more flexible controls over probes as well as filters that are to be considered by specific processing algorithms, such as feature extraction algorithms. It would further be desirable to provide a user flexibility in choosing appropriate probes and/or filters for feature extraction processing.

### SUMMARY OF THE INVENTION

Systems, methods and computer readable media are provided for extracting data from features on a chemical array. A feature extraction module may include feature extraction algorithms configured to calculate characteristics of array features. A reference table associating probe names of probes contained on the array with at least one additional identifier is provided, wherein the reference table is accessible by the feature extraction module to convert any one of the at least one additional identifiers to the probe names, and the probe names to at least one of the at least one additional identifiers.

A user interface is provided to provide a user with an editable reference table associating probe names of probes contained on a chemical array with at least one additional identifier, wherein the reference table is accessible by a feature extraction module including a plurality of feature extraction algorithms configured to determine characteristics of array features, to convert any one of the at least one additional identifiers to the probe names, and/or the probe names to at least one of the at least one additional identifiers.

Systems, computer readable media and methods for assigning a set of probes from a chemical array to a feature extraction algorithm for feature extraction processing are provided to include: defining probes by probe types; assigning at least one identifier of at least one of the probe types to the feature extraction algorithm to define specific probes from which signals are inputted for processing; providing a reference table associating probe names of probes contained on the array with the at least one additional identifier; accessing the reference table and converting the at least one identifier to the probe names; and selecting probes from the array from which signals are inputted for the processing based on the converted probe names.

Systems, methods and computer readable media are provided for processing data obtained from a chemical array using a feature extraction algorithm, including the steps of selecting a filter set to be applied to the feature extraction algorithm; and processing the chemical array using the feature extraction algorithm subject to the filter set having been selected by a user.

Systems, methods and computer readable media are provided for assigning a set of probes from a chemical array to a feature extraction algorithm for feature extraction processing, to perform the steps of: assigning at least one identifier of probe type to the feature extraction algorithm to define specific probes to consider for processing; providing a reference table associating probe names of probes contained on the array with the at least one additional identifier; accessing the reference table and converting the at least one identifier to the probe names; and selecting probes from the array to be used for the processing based on the converted probe names.

These and other advantages and features of the invention will become apparent to those persons skilled in the art upon reading the details of the systems, methods and computer readable media as more fully described below.

### BRIEF DESCRIPTION OF THE DRAWINGS

FIG. 1 illustrates a reference table associating probe names each with at least one additional identifier.

FIG. 2 illustrates an example wherein multiple different probe names are assigned to the same probes.

FIG. 3 illustrates a reference table associating probe names each with at least one additional identifier, wherein one such additional identifier includes a bit identifier.

FIG. 4 shows a table that may be referenced by the system and or a user or administrator in specifying filter sets to be applied to specific algorithms.

FIG. 5 is a schematic representation of a user interface according to the present invention.

FIG. 6A illustrates a portion of a reference table showing multiple different probes represented by the same probe name.

FIG. 6B illustrates an additional table provided to include more specific information regarding the various subtype 2 categories of the probes shown in FIG. 6A.

FIG. 7A is a schematic representation of a user interface displaying the same information as in FIG. 5, but where ProbeNames have been encrypted.

FIG. 7B illustrates an example of a up table that is accessible for conversion of encrypted strings to unencrypted data, such a ProbeName and/or various subtypes.

FIG. 8 illustrates a typical computer system in accordance with an embodiment of the present invention.

### DETAILED DESCRIPTION OF THE INVENTION

Before the present systems, methods and computer readable media are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a table” includes a plurality of such tables and reference to “the probe” includes reference to one or more probes and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

A “chemical array”, “microarray”, “bioarray” or “array”, unless a contrary intention appears, includes any one-, two-or three-dimensional arrangement of addressable regions bearing a particular chemical moiety or moieties associated with that region. A microarray is “addressable” in that it has multiple regions of moieties such that a region at a particular predetermined location on the microarray will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. Nos. 6,242,266; 6,232,072; 6,180,351; 6,171,797 and 6,323,043. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. Scanning typically produces a scanned image of the array which may be directly inputted to a feature extraction system for direct processing and/or saved in a computer storage device for subsequent processing. However, arrays may be read by any other methods or apparatus than the foregoing, other reading methods including other optical techniques or electrical techniques (where each feature is provided with an electrode to detect bonding at that feature in a manner disclosed in U.S. Pat. Nos. 6,251,685, 6,221,583 and elsewhere).

A “design file” is typically provided by an array manufacturer and is a file that embodies all the information that the array designer from the array manufacturer considered to be pertinent to array interpretation. For example, Agilent Technologies supplies its array users with a design file written in the XML language that describes the geometry as well as the biological content of a particular array.

A “grid template” or “design pattern” is a description of relative placement of features, with annotation, that has not been placed on a specific image. A grid template or design pattern can be generated from parsing a design file and can be saved/stored on a computer storage device. A grid template has basic grid information from the design file that it was generated from, which information may include, for example, the number of rows in the array from which the grid template was generated, the number of columns in the array from which the grid template was generated, column spacings, subgrid row and column numbers, if applicable, spacings between subgrids, number of arrays/hybridizations on a slide, etc. An alternative way of creating a grid template is by using an interactive grid mode provided by the system, which also provides the ability to add further information, for example, such as subgrid relative spacings, rotation and skew information, etc.

A “grid file” contains even more information than a “grid template”, and is individualized to a particular image or group of images. A grid file can be more useful than a grid template in the context of images with feature locations that are not characterized sufficiently by a more general grid template description. A grid file may be automatically generated by placing a grid template on the corresponding image, and/or with manual input/assistance from a user. One main difference between a grid template and a grid file is that the grid file specifies an absolute origin of a main grid and rotation and skew information characterizing the same. The information provided by these additional specifications can be useful for a group of slides that have been similarly printed with at least one characteristic that is out of the ordinary or not normal, for example. In comparison when a grid template is placed or overlaid on a particular microarray image, a placing algorithm of the system finds the origin of the main grid of the image and also its rotation and skew. A grid file may contain subgrid relative positions and their rotations and skews. The grid file may even contain the individual spot centroids and even spot/feature sizes. Further information regarding design files, grid templates, design templates and grid files and their use can be found in co-pending, commonly owned application Ser. No. 10/946,142 filed Sep. 20, 2004 and titled “Automated Processing of Chemical Arrays and Systems Therefore. application Ser. No. 10/946,142 is hereby incorporated herein, in its entirety, by reference thereto.

A “history” or “project history” file is a file that specifies all the settings used for a project that has been run, e.g., extraction names, images, grid templates protocols, etc. The history file may be automatically saved by the system and is not modifiable. The history file can be employed by a user to easily track the settings of a previous batch run, and to run the same project again, if desired, or to start with the project settings and modify them somewhat through user input.

“Image processing” refers to processing of an electronic image file representing a slide containing at least one array, which is typically, but not necessarily in TIFF format, wherein processing is carried out to find a grid that fits the features of the array, to fine individual spot/feature centroids, spot/feature radii, etc. Image processing may even include processing signals from the located features to determine mean or median signals from each feature and may further include associated statistical processing. At the end of an image processing step, a user has all the information that can be gathered from the image.

“Post processing” or “post processing/data analysis”, sometimes just referred to as “data analysis” refers to processing signals from the located features, obtained from the image processing, to extract more information about each feature. Post processing may include but is not limited to various background level subtraction algorithms, dye normalization processing, finding ratios, and other processes known in the art.

A “protocol” provides feature extraction parameters for algorithms (which may include image processing algorithms and/or post processing algorithms to be performed at a later stage or even by a different application) for carrying out feature extraction and interpretation from an image that the protocol is associated with. Protocols are user definable and may be saved/stored on a computer storage device, thus providing users flexibility in regard to assigning/pre-assigning protocols to specific microarrays and/or to specific types of microarrays. The system may use protocols provided by a manufacturer(s) for extracting arrays prepared according to recommended practices, as well as user-definable and savable protocols to process a single microarray or to process multiple microarrays on a global basis, leading to reduced user error. The system may maintain a plurality of protocols (in a database or other computer storage facility or device) that describe and parameterize different processes that the system may perform. The system also allows users to import and/or export a protocol to or from its database or other designated storage area.

An “extraction” refers to a unit containing information needed to perform feature extraction on a scanned image that includes one or more arrays in the image. An extraction includes an image file and, associated therewith, a grid template or grid file and a protocol.

A “feature extraction project” or “project” refers to a smart container that includes one or more extractions that may be processed automatically, one-by-one, in a batch. An extraction is the unit of work operated on by the batch processor. Each extraction includes the information that the system needs to process the slide (scanned image) associated with that extraction.

A “probe name” is a name identifying a specific probe, dependent upon the particular chemical moiety that is bound to the array at the site of the probe that the probe name identifies. Probe names are non-robust when used as a method of identification, such as for determining a set of probes to be processed by an algorithm, because it is possible for probes containing the same chemical moiety to be assigned different probe names by different array manufacturers, for example. Further, probe names may change when naming conventions are changed, so a newer array containing the same probe as an older array may have a different name for that probe. Examples of probe names include, but are not limited to, some unique derivation of a gene name that distinguishes itself from other probes targeting the same gene; some unique derivation of a sequence identifier (e.g., such as gene accession numbers) such that it distinguishes itself from other probes targeting the same accession; custom identifiers (e.g., identifiers generated by a customer providing a probe design); or a unique catalogued string such that any probe not of the same sequence will not duplicate any already existing name. Probe names may comprise alphanumeric and/or other types of symbols which may have a readily recognizable meaning (e.g., such as in the case of a gene name) or may have meaning only after association with data (e.g., in a relational database) or other reference.

A “probe type” identifies a class of probes, and typically identifies one or more functions that the class of probes is designed for. For example a “BrightCorner” type is a subtype of positive control type that is used to illuminate the corners of the array image when the proper sample preparation protocol is run.

A “subtype” or “probe subtype” further characterizes a subtype. Subsets of a probe type may be identified by different subtypes, and subtypes of subtypes may be used to distinguish subsets of a particular subtype. For example, three different probes may all belong to the same probe type, with the first probe having a subtype1 of name A1 and a subtype 2 of name B1, the second probe may have a subtype1 of name A1 and a subtype2 of name B2 and the third probe may have a subtype1 of name A2 and may not have a subtype2 assigned to it.

The term “control type” identifies the class of probes that also may be identified by probe type. For example, control type=−1 refers to probe types often referred to as “negative controls”, control type=0 refers to probes that are sometimes also referred to as “non-controls” and are typically the probes upon which experiments are conducted, and control type=1 or control type=+1 refers to probe types often referred to as “positive controls”.

When one item is indicated as being “remote” from another, this is referenced that the two items are at least in different buildings, and may be at least one mile, ten miles, or at least one hundred miles apart.

“Communicating” information references transmitting the data representing that information as signals (e.g., electrical, optical, radio, etc.) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

All patents and other references cited in this application, are incorporated into this application by reference except insofar as they may conflict with those of the present application (in which case the present application prevails).

The present invention provides flexible and adaptable systems and methods for selection of specific probes to be used by feature extraction algorithms. Filter sets may also be flexibly applied to particular feature extraction algorithms. A reference or look-up table may be generated that associates each probe name on an array to one or more specific probe types. As such, probe names do not need to be parsed for use with specific algorithms, as a selection of probes for use by a specific algorithm may be made directly by identification of one or more probe types and/or probe subtypes.

A probe type table as described herein may be updated by an array manufacturer, such as by downloading updates over the Internet, or by changing design files that are shipped with each array. Probe type tables may be made available to users and may be interactively customized with associations for their own needs.

By referencing a probe type table as described, feature extraction algorithms may associate desired/specified probes to each algorithm in accordance with identification by use of the probe type reference table. Since the feature extraction algorithms reference specified probe type and subtypes, parsing of probe names is not necessary.

The association of probe types with probe names does not need not be hard-coded, rather, associations can be made available as a method, available to the user for customization via a user interface.

Feature extraction algorithms may further apply desired filter sets to specific algorithms as specified in a filter table. Filter tables may also be made available as a method to a user for customization via the user interface. Further, the system may provide default methods for one or more (or all) specific algorithms wherein the feature extraction software associates specified default filter sets with regard to each algorithm as specified. Users may customize applications of filter sets to specific algorithms through the user interface.

By associating specific feature extraction algorithms with specific probe types, the present invention is robust to different array manufacturing probe specifications, and even allows users to create probe types for arrays that are manufactured without any probe type specifications. Further, a probe type table can be easily updated after release of a commercial software package containing such table. Still further, a probe type table can be customized by a user of the feature extraction system, through a user interface.

The link between probe name and/or type, subtype, etc. and the algorithms that may be defined by a manufacturer to use that particular probe name and/or type, subtype, etc. may be provided in a secure manner to prevent reverse engineering or copying of algorithms provided by the manufacturer, as the security provided would prevent a user from readily identifying which probes are used in groups of probes as a basis upon which to execute and algorithm. For example, a hash function, such as MD5 or SHA1, may be used to output a string of data based on the probe name plus a secret string (provided by the manufacturer) held by an algorithm. If the output of the hash function is in the lookup table of probes to be used for that algorithm, then that probe would be used as a member of the set of probes upon which to execute the algorithm. Without knowledge of the secret string, and/or the algorithm used to compute the output string, it is not possible to determine which probes will be used as members of this set of probes. Many alternative methods of computing such a string of data are available, as would be apparent to one skilled in the art.

By also providing for flexibility and customization of control of specific filter sets that can be associated with specific feature extraction algorithms, the systems allows flexibility to developers of the feature extraction algorithms. Filter tables can also be easily and flexibly updated after release of a commercial feature extraction software product. Filter tables can also be customized by users via the user interface.

Feature extraction algorithms can be directed to run based on a set of probes from an array characterized by a specific probe type, or a set from more than one specified probe types, e.g., when a feature extraction algorithm references a probe type table, specific probes that are identified by a pre-specified probe type(s), etc, can be included by the algorithm for specific selection of the probes on a particular array to be processed. For additional specificity and flexibility, subtypes of probe types may be defined and associated with probes in a probe type table. For example, as noted above, probes may be broadly characterized according to negative controls probe type, positive controls probe type and non-control probe types, which are the experimental probes on an array. However, there may exist different types of probes within these broad control type categories. One example of a negative control probe type that has been developed results in a very low amount of binding to target, and is often referred to as a structural hairpin probe. These probes are generally categorized as negative controls and can therefore be assigned probe type=negative control (also control type=−1).

The feature extraction system includes a background method algorithm that uses all probe type=negative control to estimate the background signal that should be subtracted from all features on the array. Supposing that a new type of negative control probe has been developed that is not a structural hairpin, but provides an estimate of background based upon a different principle, these probes would also be assigned probe type=negative control. In order to allow development and improvement of algorithms, the present system provides for distinguishing between these different types of negative controls through the assignment of probe subtypes. Thus, for example, the hairpin probes may be assigned subtype=structural, while the newly developed type of negative control probe mentioned above may be assigned subtype=new sequences. This allows the algorithm developers and users to choose either or both subtypes for use in the background algorithm.

Similarly, the probe type labeled as positive control may include many different subtypes of probes. For example, bright corner probes (e.g., positive control type probes placed at the corners of an array to help in locating the array during feature analysis), array synthesis monitor probes (monitoring various sources of possible manufacturing errors, such as nozzles, etc.), and spike-in probes are all considered positive control probe types, but all serve different specific functions. By assigning each of these probe types to not only control type=positive control, but also to different specific subtypes, greater specificity can be applied in choosing which specific types of positive control probes are to be used by a specific algorithm. For example, BrightCorner probes may be specified for a gridding algorithm to assist in accurate placement of the grid for locating all probes, while spike-in probes (or a subset thereof) may be used for dye normalization, or for calculation of QC metrics. Spike-in probes can be used for one or more populations from which statistics can be calculated. For example, as described below, Absolute Average Log Ratio and Average signal-to-noise of non-control probes may be compared with spike-in probes. These statistics may be characterized for each subset of spike-in probe populations where more than one type of spike-in probe is present on an array.

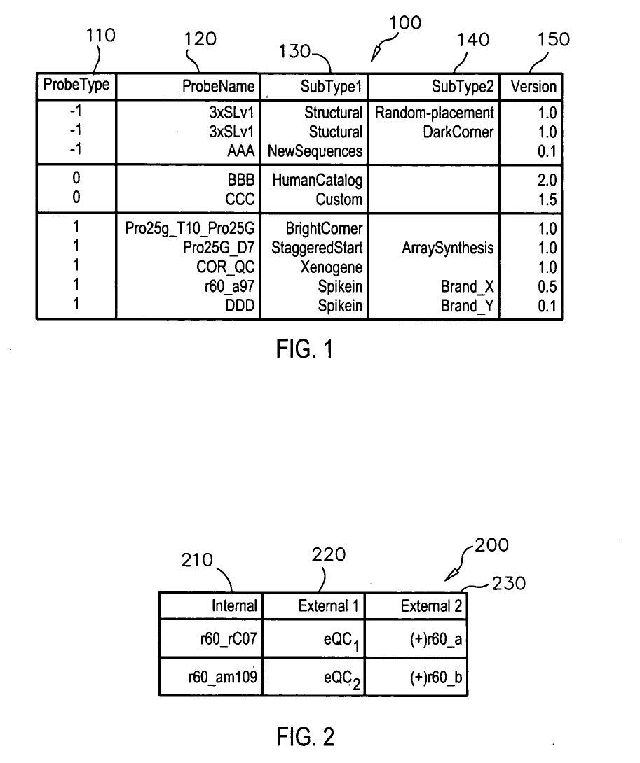

Still further, particular subtypes may be broken down into more specific categories, referred to in FIG. 1 as “subtype 2”. Thus, for example, subtype=spike-in may be further distinguished and categorized, depending upon another variable such as the type of spike-in target that will bind to the spike-in probes. For example, all spike-in probes may be assigned control type=positive control, subtype 1=spike-in, and then, depending upon the particular type of spike-in target that will bind to the spike-in probe, the probe may be assigned subtype 2=Brand X or subtype 2=Brand Y, etc.

FIG. 1 shows an example of a probe type reference table 100 or “common controls table” useable by feature extraction algorithms. Probe types are identified in column 110. As noted above, there may be more than one probe name associated with each probe type, and this is shown in column 120 that lists the probe names, as probe type−1 has two different probe names assigned to it, probe type 0 has two different probe names assigned thereto, and probe type 1 has five different probe names assigned thereto. It should be noted here that FIG. 1 is just a simple example of a reference table, for the purpose of simplicity and clarity of the explanation of the principles shown. Many more probe names may be, and typically are assigned to such a table. For example, there are currently at least ten different probe names of the spike-in variety that may be assigned to probe type 1. Further, as already noted, table 100 may be modified, either by a software manufacturer or a user, or both, to include still more probes and probe names.

The subtype 1 column characterizes the probe names with further specificity. Thus, for example, a query for negative control probe types with a subtype 1 identified as structural will identify only the first two probe names shown, and not the third (“AAA”), giving flexibility for selection of only a select subset of control type−1 probes for use by an algorithm. This may be useful, for example, if the “NewSequences” probes, (probe name AAA) are not fully tested and therefore a user does not want to rely upon them for running a background algorithm. On the other hand, those testing the new sequences can select only the new sequences for calculation of background, and/or a combination of structural and new sequences (i.e., all of the probe type−1 probes) to run the same background algorithm, for comparison and evaluation of the new sequences probes relative to the results achieved when only the structural probes were selected to run the background algorithm.

The subtype 2 designations shown in column 140 may be used to still further distinguish and specify a subset of probe types. For example, the functions or other designations in subtype 1 may be the same for different probes. Note, for example, that the negative probe types listed in table 100 include two listings of probe type−1, subtype 1 structural, each of which also is assigned the same probe name (i.e., “3×SLv1”). However, those probes listed are distinct with regard to their placement/position occupied on the array. This placement is specified by the subtype 2 designations for the probes, where the first probe listed has a subtype 2 designation 140 of “random-placement” and the second probe listed has a subtype 2 designation 140 of “dark corner” (e.g., a negative type probe positioned as the corner feature of an array of features). Thus, if a user is interested in using only the randomly placed, structural, negative control probes for a particular algorithm such as a background algorithm, for example, then this can be specified with regard to that background algorithm by specifying probe type, subtype 1 and subtype 2 specifications. A version number for each probe may also be specified in column 150, so that, upon review, a user or software administrator can readily check to see that table 100 is up to date.

Probe type reference table 100 may be provided in the design file associated with an array so that probe types 110, and optionally subtypes 1 and 2 are associated with each specific probe name that is indicated for that array. Such a design file may be shipped with the array and used by feature extraction software to identify the specific probes that are required for processing by each specific algorithm run during feature extraction. Additionally, the design file (and specifically table 100) may be updated at the user end, such as by downloading updates over the Internet, for example.

For arrays for which not all (or none) of the probe names and specifications are known, probe type reference table 100 may be maintained in a database associated with the feature extraction software. Table 100 is loaded into a database that is shipped with the feature extraction software. Table 100 may be updated at the user end, such as by downloading updates over the Internet, for example, such as when probe names become known or available for release and if such names are known by the operator performing the download. As noted earlier, table 100 can keep track of versions 150 for each probe name 120 to keep track of changes and which version has been used for specific extractions. Table 100 may also have a version assigned to the overall table.

The chart 200 in FIG. 2 illustrates an example of underlying complexity provided by probe names that may be presented when trying to select a set of probes for use by a feature extraction algorithm by probe name. In this example, probe names 210 (i.e., r60_rC07 and r60_am109) provided in an internal design file used by a manufacturer of an array are provided. The probes in this example are currently in development by the manufacturer and therefore the manufacturer does not want to publish the probe names to the users at this time. Accordingly, for external design files (i.e., design files actually shipped to the user with the arrays), different code names were substituted for the internal probe names 210 as External 1 probe names 220. In another release of the arrays, the probe names of these same probes were changed in the design files shipped with the new release of arrays, from eQC1 and eQC2 to (+)r60_a and (+)r60_b, as shown under the External 2 probe names 230. As can be readily understood, a query required to identify the positive controls by the names of r60_rC07 and r60_am109 for a specific feature algorithm can rapidly become complex, as all of the alternative names for each probe must also be considered in order for the feature extraction system to be generally useable with all of the arrays. Further, it is not atypical for a design file to include still further naming conventions for probes that are otherwise identifiable under other probe names by feature extraction software. When this occurs, a query cannot be adequately defined to locate all probes required for a specific feature extraction algorithm if there are probes existing on an array named by another probe naming convention that is not known or defined in the feature extraction software.

In contrast, using a reference table 100, all six of the probe names indicated in chart 200 would be assigned the same probe type (in this case, positive, or +1). A specific algorithm requiring use of the probes identified in FIG. 2 could then simply be identified by locating probe type=1, without the need to parse all six of the probe names indicated. If these probes are designed for a specific function, and other positive control probes exist on the array, these probes may be specifically identified (to the exclusion of the other positive control type probes on the array) by simply specifying a subtype 1 (and a subtype 2, if needed).

Some feature extraction algorithms may need to use a specific probe set identified by probe type, subtype 1 and/or subtype 2, etc., but that probe set has been selected outside of (i.e., independently of) the feature extraction processing. The feature extraction system is programmed to look for (e.g., query) the particular probe type(s), and/or subtypes (e.g., subtype(s) 1 and/or subtype(s) 2, and/or . . . and/or subtype(s) n, where there may be any positive number of subtypes defined in the table) when performing that algorithm. For example, a dye normalization algorithm may use a probe set which is chosen using a separate methodology. The dye norm probes may be selected using a method described in U.S. Patent Publication No. 2006/0046252 which published on Mar. 2, 2006 and is titled “Method And System For Developing Probes For Dye Normalization Of Microarray Signal-Intensity Data, (which probes are referred to as synthetic universal dye norm probes) or using a methodology as described in U.S. Patent Publication No. 2006/0004527 which published on Jan. 5, 2006 and is titled “Methods, Systems and Computer Readable Media for Identifying Dye-Normalization Probes”(where probes show least variation of log ratios over a whole range of experiments). U.S. Patent Publication Nos. 2006/0046252 and 2006/0004527 are hereby incorporated herein, in their entireties, by reference thereto.

Dye normalization may be performed using spike-in probes. Since dye normalization probe selections are generally made outside (e.g., independently) of feature extraction processing, it is necessary to somehow decouple the developmental life cycle of these methodologies and the feature extraction software. One way of decoupling is through the use of probe type reference table 100 to specify which probes to use for dye normalization. If the probes are “universal dye norm probes”, that is, they are identified as well known in the field for use as dye normalization probes, then the subtype 1 of “dye norm” can be used globally. If dye normalization probes are selected for a particular cell line (using the methodology described in U.S. Patent Publication No. 2006/0004527, for example), then reference table 100 needs to be associated with particular arrays that carry sequences expressed by that particular cell line, such as by using a unique identifier (or series of unique identifiers) that identifies that particular array or arrays with the cell line.

Probe types may each have an identifier assigned that uniquely identifies each probe type by software, such as feature extraction software referencing the probe types. This unique identifier convention may further be applied to unique subtype 1's and subtype 2's within probe types so that each unique classification of probes is assigned a unique identifier. Where the number of unique classifications is relatively small, each unique identifier can also act as a software bit field. Use of a bit field makes it easy for software to group probe types and subtypes (both subtype 1 and subtype 2, and any further division by additional subtypes that may be defined) into various populations to be used in algorithms related to feature extraction, quality control, etc. This approach thereby eliminates the need to identify and search by probe types and subtypes, as each unique categorization of probe type, subtype 1, subtype 2, etc., is assigned a unique bit number. Thus, Boolean logic may be employed to implement such population grouping. As an example, positive control type may be bit-identified as 1, negative controls as 2 (i.e., bit identifier=10), non-controls as 0, etc. Exemplary bit-identifier assignments to subtype 1 categories of positive controls include “bright corners” identified as 9 (i.e., 1001), “array synthesis monitors” identified as 17 (i.e., 10001), and “spike-ins” identified as 33 (i.e., 100001). Note that additionally, spike-ins or other probes that are further categorizable such as by subtype 2 categorization may each be assigned a unique bit-identifier. Also, it should be noted that these bit-identifiers need not necessarily be assigned as described above, but may be arbitrarily assigned, as long as a unique bit-identifier is applied to differentiate each category and these bit-identifiers are assigned consistently for use by the system.

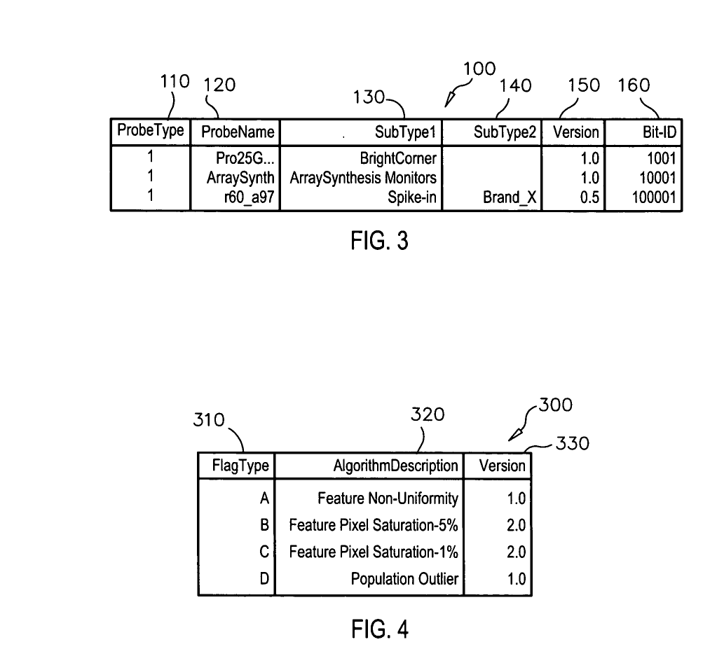

Using bit-identifiers from the example above, a population of positive control types having the desired characteristics can easily be assembled using simple Boolean logic. For example, by searching a list via bit fields with bits 4 and 5 set (i.e., 11000), the search retrieves all bright corners probes and all array synthesis monitors probes. The software and/or user implementing the query do not even need to know that the bright corner probes or array synthesis monitors probes are also positive controls. The bit field containing the bit-identifiers can be exported as a parameter that a sophisticated or internal user may set to configure the population to be used by a given algorithm as long as the mapping of subtypes and their corresponding identifiers is well understood. The bit-identifiers may also be contained in table 100, such as in column 160 in FIG. 3.

The system may specify a default list of filter sets to be used for each algorithm. The default list may be either hard-coded and over-writable from a user interface 400 (described in more detail below), or may be completely specified via user interface 400. FIG. 4 shows a table 300 that may be referenced by the system and or a user or administrator in specifying filter sets to be applied to specific algorithms. Column 310 contains an identifier of flags that may be set by algorithms run during feature extraction to characterize features as to uniformity as well as characterizations of signals received from the features. Other quality algorithms may be run as well to flag features that do not pass a particular quality assessment as processed by that algorithm. Column 320 gives a description of the meaning of each flag, which is useful when referred to by a user or administrator, to identify what the flags are flagging for. Column 330 may optionally be included to indicate the version of the algorithm used for that particular flagging process.

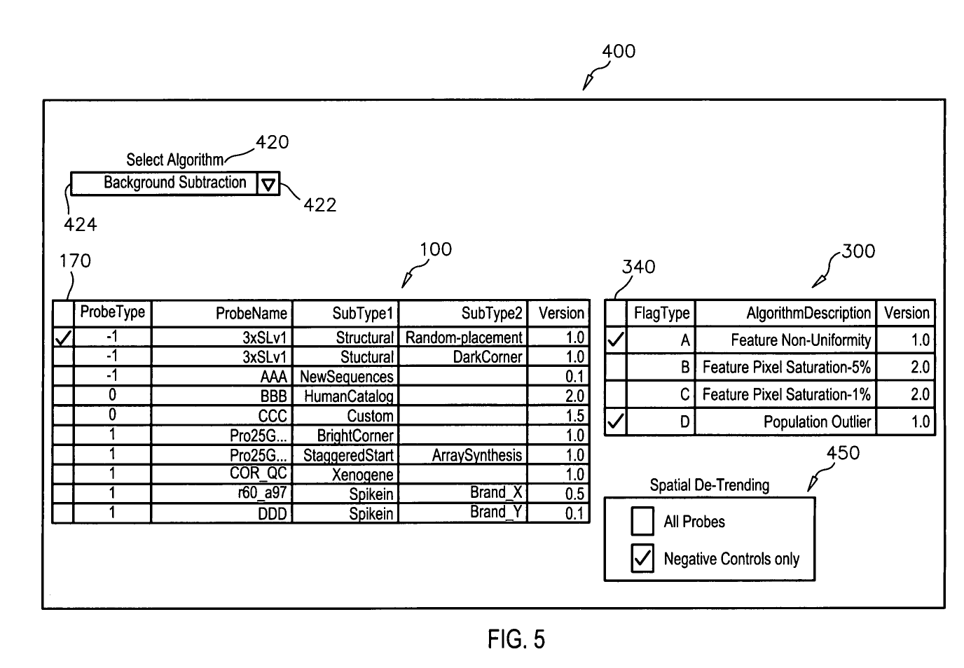

Thus, an administrator or user may define not only the probes to be considered by a specific algorithm, but also a filter set that is applied to further limit the probes that are ultimately considered for processing. For example, a user may decide that, for running a specific dye normalization algorithm, that only subtype 2 random placement probes are to be used and that flags A and D are to be applied. FIG. 5 is a schematic representation of a user interface 400 that includes interactive features through which a user can specify run characteristics of particular feature extraction algorithms. Feature 420 includes a drop down menu or other feature from which a user may select a specific feature extraction algorithm to be characterized. By clicking on or otherwise selecting button 422, a drop down menu appears with a list identifying specific feature algorithms from which the user may select a specific algorithm by clicking on (or through highlighting and selecting by a keystroke, for example) an algorithm of interest. The selected algorithm may then be displayed in text box 424. In the example shown, the user has selected a background subtraction algorithm.

Tables 100 and 300 may be additionally accessed through user interface 400 and the user can then directly and interactively select specific probe types, or subtypes to be used by the selected algorithm, as well as any filters to be applied. The choices that have been selected by the user may be visually indicated in the user interface 400, such as by check marks 170, 340, highlighting or some other visual feedback, to let the user know that the user's selections have been registered. In the example shown, the user has selected the random placement, structural subset of negative control probes, with further filtering by feature non-uniformity and population outlier flags to be applied for background subtraction processing.

User interface 400 may provide the user with further interactive controls. One example of such additional controls is illustrated in FIG. 5, where spatial detrending controls 450 are provided giving the user the choice of whether to consider all probes for performing a spatial detrending algorithm or to use only negative controls probes on the array. In this example, the user has selected to use only negative controls probes. The spatial detrending algorithm may apply a moving window over the array to identify the lowest signals over the surface of the probes used to identify if a gradient exists. This gradient is then subtracted out as one method used toward normalizing the signals across all probes.

In addition to providing the ability to select a subset of probes from an array based upon probe type and or subtype (subtype 1, subtype 2, and additional subtypes, if present) or directly by bit-identifier, table 100 also provides the feature extraction software with the ability to characterize probes as to probe type, subtype, etc., based upon a probe name that is associated with an array being processed (such as in a design file, for example). That is, the feature extraction system, using table 100 can map all the probe names associated with an array to particular probe types (as well as subtype 1, subtype 2, etc.) when these categorizations are not already contained in the information associated with the array (such as in the design file), as long as the probe names are contained in table 100. Once fully mapped, feature extraction software can proceed with selection of the appropriate probes needed for any particular feature extraction algorithm. For example, a dye normalization algorithm may specify to exclude all negative controls and positive controls, and this is easily accomplished based upon the probe type identification accomplished through mapping.

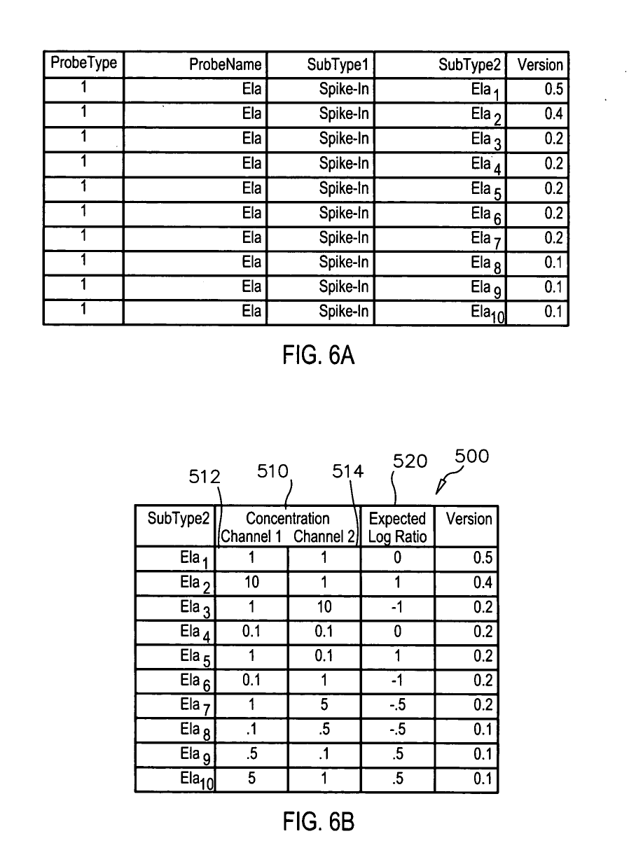

Other information may be associated with probes that may not be appropriate to be maintained in table 100 as not being used directly for categorization of the probes. Such information may be included in separate files or tables and cross-referenced by probe type (e.g., the most specific categorization of probe type, including subtype 1, subtype 2 or any further level of detail of categorization that may exist) and/or probe name to table 100. For example, consider a probe subtype 1 “spike-in” with probe name E1a having ten different subtype 2 categories, as illustrated in FIG. 6A, which shows a portion of a probe type table 100 that includes ten E1a spike-in probe categorizations. A separate table 500 may be provided, such as shown in FIG. 6B, for example, to include more specific information regarding the various subtype 2 categories of E1 a spike-in probes.

For example, table 500 may include the concentration 510 of the chemical moiety associated with each probe (e.g., such as from a labeled, hybridized target) with respect to a first channel 512 (e.g., red channel) and a second channel 514 (e.g., green channel), as well as the expected signal log ratio 520 (e.g., log ratio of the red channel to the green channel) from the probe when hybridized and feature extracted, given those concentrations. In FIG. 6B, cross-referencing between table 500 and probe type table 100 is achieved by subtype 2 names. Optionally, versions of this information may be tracked, similar to that described with regard to table 100.

Table 500 may be used to still further add specificity and flexibility in choosing a select population of probes to be used by a specific algorithm during processing. For example, for feature extraction algorithms producing sensitivity-related metrics, a user may be interested in using only relatively high sensitivity spike-in probes. To accomplish the selection, the user may establish a query to find E1a probes having a concentration of less than 1 in channel 1 and less than 0.5 in channel 2. In response, the system would assign probes E1a4 and E1a9 to be used by the specific algorithm as the assigned probes on which processing is to occur. Additionally, the system may then cross-reference subtype 2 probe designations E1a4 and E1a9 back to table 100 to identify probe names of any probes that are assigned either one of those subtype 2 designations. As noted earlier there may be more than one probe name used for each of these subtype 2 categories, given the many different naming conventions that have been used. With an up-to-date table 100, the system may then identify each pertinent name and search the array design file to find all occurrences of any of those names for initial selection for use with the specific algorithm. Of course these selections may be further subject to filtering, as described above.

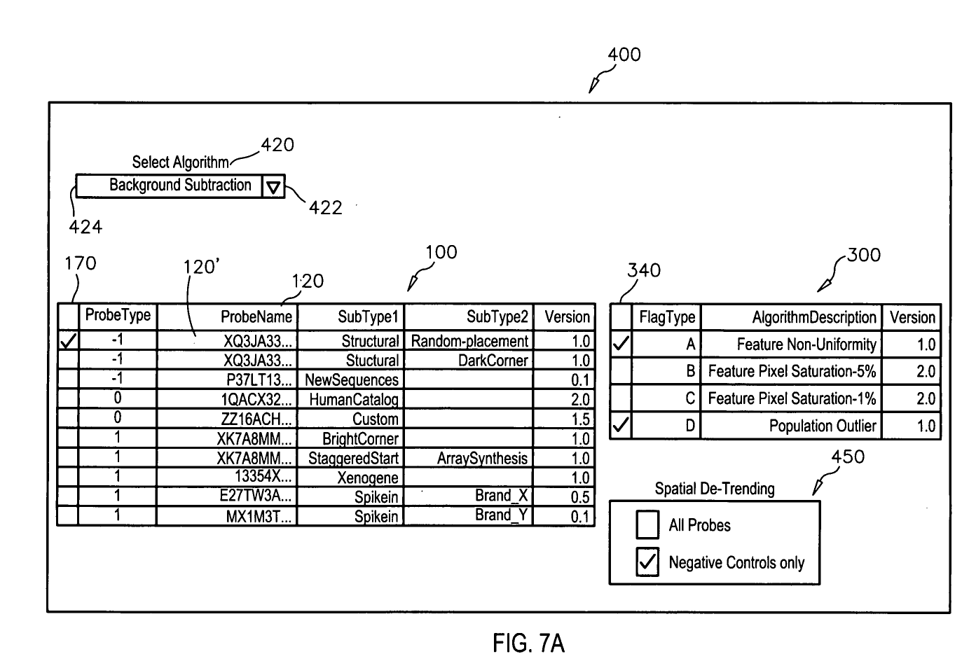

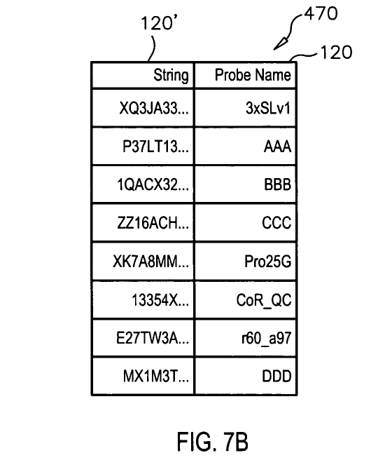

As mentioned above, the system may be provided with security features so that the link between probe name and/or type, subtype, etc. and the algorithms that may be defined by a manufacturer to use that particular probe name and/or type, subtype, etc. may be provided in a secure manner to prevent reverse engineering or copying of algorithms provided by the manufacturer. FIG. 7A shows an example of user interface 400 wherein the ProbeNames 120 have been encrypted and represented as strings 102′, so that a user may not identify the names of the probes. In one embodiment, a look up table 470 (e.g., see FIG. 7B) is provided that is accessible by the algorithm, but not the user, to convert strings 120′ to ProbeNames 120, whereby the algorithm can then select probes in a manner as described above, based upon the indicated ProbeNames 120 and/or subtypes specified. If a user adds additional ProbeNames to be considered for processing by an algorithm, the algorithm encrypts the added ProbeNames and then accesses lookup table 470 to see if the encrypted strings that were calculated match any of the strings in table 470. When a match is found, the ProbeName corresponding to the matching string can be added to the group of probes to be processed by the algorithm. The encrypted strings for the ProbeNames are what are displayed to the user, such as shown, for example in FIG. 7A.

However, the mechanism for determining the encrypted name to be looked up in the reference table need not be a look up table. As noted earlier, a hash function may be employed. For example, the a hash function can be employed to convert a probename to an encrypted name that is secure and cannot be converted back to the unencrypted probename without additional information, such as a key, for example, and the conversion is thus irreversible absent that additional information. By applying a hash function (e.g., MD5 hash function, SHA1 hash function, or the like) to the probename and providing a secret key appended to the probename, an encrypted probename can be converted back to the unencrypted probename using the secret key and hash function. A look up table 470 as described can alternatively be used for encryption, as described, but may be less flexible than application of a hash function and secret key, since updating the reference table can add or drop probe names from an algorithm, which can then be converted on the fly by a hash function, but additions and deletions are more difficult if the look up table is built into the algorithm. In general, any encryption method that facilitates a processing algorithm to convert a probename into an encrypted probename, so that the encrypted probename appears in the reference table may be used, as long as it is secure (i.e., conversion from encrypted probename to unencrypted probename cannot be carried out without some additional information) and irreversible (i.e., an unencrypted probename cannot be determined from its encrypted probename without some additional information).

Note that although all ProbeNames 120 are shown as encrypted in FIG. 7A, that encryption may be performed on only a subset of all ProbeNames, as desired by the system manufacturer. For example, protection may only be desired for the ProbeNames AAA, BBB, CCC and DDD, in which case all of the other ProbeNames in FIG. 5 may be displayed by their unencrypted names. In either case, the system may also be configured such that ProbeNames added by a user are not encrypted, but are shown by the names provided by the user.

Still further, the one or more subtypes (e.g., SubType1, SubType2, etc.) may be additionally or alternatively encrypted in any of the same manners described above with regard to ProbeName, wherein look up table 470 would then include the strings and subtype names having been encrypted.

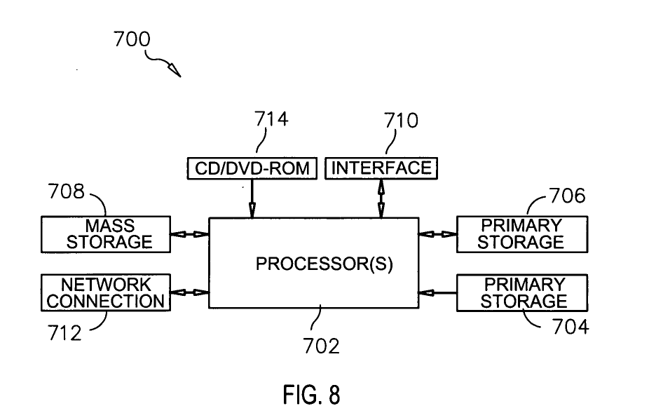

FIG. 8 illustrates a typical computer system in accordance with an embodiment of the present invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). As is well known in the art, primary storage 704 acts to transfer data and instructions uni-directionally to the CPU and primary storage 706 is used typically to transfer data and instructions in a bi-directional manner Both of these primary storage devices may include any suitable computer-readable media such as those described above. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk that is slower than primary storage. It will be appreciated that the information retained within the mass storage device 708, may, in appropriate cases, be incorporated in standard fashion as part of primary storage 706 as virtual memory. A specific mass storage device such as a CD-ROM or DVD-ROM 714 may also pass data uni-directionally to the CPU.

CPU 702 is also coupled to an interface 710 that includes one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to a computer or telecommunications network using a network connection as shown generally at 712. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for providing interactive tools for a user interface may be stored on mass storage device 708 or 714 and executed on CPU 708 in conjunction with primary memory 706.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A system for extracting data from features on a chemical array, said system comprising:
a feature extraction module including feature extraction algorithms configured to calculate characteristics of array features;
a reference table associating probe names of probes contained on the array with at least one additional identifier; wherein said reference table is accessible by said feature extraction module to convert any one of said at least one additional identifiers to said probe names, and said probe names to at least one of said at least one additional identifiers.

2. The system of claim 1, wherein said at least one additional identifier comprises a probe type.

3. The system of claim 2, wherein said at least one additional identifier comprises a subtype.

4. The system of claim 1, wherein said at least one additional identifier comprises a bit identifier.

5. The system of claim 1, wherein said reference table is provided as a method, said method facilitating modification of said reference table.

6. The system of claim 1, wherein said reference table is provided in a database accessible by said feature extraction module.

7. The system of claim 1, wherein said reference table is provided in a design file associated with the array.

8. The system of claim 1, further comprising at least one additional table containing additional information characterizing at least one probe on the array, said additional information being cross-referenced to the same at least one probe in the reference table, based on at least one of said probe name and said at least one identifier.

9. The system of claim 1, further comprising a list of filters selectable for application to a specific feature extraction algorithm as run by said feature extraction module.

10. The system of claim 1, wherein at least a subset of said probe names are encrypted in said reference table, and at least one of said feature extraction algorithms is configured to process the encrypted probe names as well as unencrypted probe names.

11. The system of claim 1, wherein said reference table is modifiable by a user.

12. The system of claim 1, wherein said reference table is interactively modifiable by a user.

13. The system of claim 8, wherein said filters are selectable and de-selectable by a user.

14. A user interface comprising:
an editable reference table associating probe names of probes contained on a chemical array with at least one additional identifier, wherein said reference table is accessible by a feature extraction module including a plurality of feature extraction algorithms configured to determine characteristics of array features, to convert any one of said at least one additional identifiers to said probe names, and/or said probe names to at least one of said at least one additional identifiers.

15. The user interface of claim 14, wherein at least a subset of said probe names in said reference table are encrypted.

16. The user interface of claim 14, further comprising a list of filters selectable for application to a specific feature extraction algorithm.

17. The user interface of claim 16, wherein filters in said list are selectable by the user for application to the specific feature extraction algorithm, and selectable to be removed from application to the specific feature algorithm.

18. The user interface of claim 14, further comprising at least one additional table containing additional information characterizing at least one probe on the array, said additional information being cross-referenced to the same at least one probe in the reference table, based on at least one of said probe name and said at least one identifier.

19. The user interface of claim 14, further comprising a feature for user selection and de-selection of probes by probe name or one of said additional identifiers, thereby identify probes from which signals are inputted for calculation by a specific algorithm.

20. The user interface of claim 14, further comprising a display of a list of specific algorithms, a specific algorithm being selectable from said list to apply settings from said editable reference table thereto.

21. The user interface of claim 20, wherein at least a subset of at least one of probe names and subtypes that further characterize probes identified by said probe names are displayed as encrypted strings in said user interface.

22. A method of assigning a set of probes from a chemical array to a feature extraction algorithm for feature extraction processing, said method comprising:
defining probes by probe types;
assigning at least one identifier of at least one of said probe types to the feature extraction algorithm to define specific probes from which signals are inputted for processing;
providing a reference table associating probe names of probes contained on the array with said at least one additional identifier;
accessing said reference table and converting said at least one identifier to said probe names; and
selecting probes from the array from which signals are inputted for said processing based on said converted probe names.

23. The method of claim 22, further comprising
modifying said reference table;
accessing said reference table and converting said at least one identifier to said probe names; and
selecting probes from the array to be used for said processing based on said converted probe names.

24. A method of processing data obtained from a chemical array using a feature extraction algorithm, said method comprising:
selecting a filter set to be applied to the feature extraction algorithm; and
processing the chemical array using said feature extraction algorithm subject to said filter set having been selected by a user.

25. The method of claim 24, further comprising modifying the filter set via a user interface, and repeating said processing step based on the modified filter set.

26. A computer readable medium carrying one or more sequences of instructions for assigning a set of probes from a chemical array to a feature extraction algorithm for feature extraction processing, wherein execution of one or more sequences of instructions by one or more processors causes the one or more processors to perform the steps of:
assigning at least one identifier of probe type to the feature extraction algorithm to define specific probes to consider for processing;
providing a reference table associating probe names of probes contained on the array with said at one additional identifier;
accessing said reference table and converting said at least one identifier to said probe names; and
selecting probes from the array to be used for said processing based on said converted probe names.
